(19) United States
(12) Patent Application Publication
(10) Pub. No.: US 2013/0155547 A1
(43) Pub. Date: Jun. 20, 2013

(54) DAMPING MATERIAL TO INCREASE A DAMPING RATIO

(71) Applicants: Hajime Eguchi, Kanagawa (JP); Naoaki Kanada, Sagamihara-shi (JP)

(72) Inventors: Hajime Eguchi, Kanagawa (JP); Naoaki Kanada, Sagamihara-shi (JP)

(21) Appl. No.: 13/330,478

(22) Filed: Dec. 19, 2011

(51) Int. Cl. G11B 5/48; G11B 17/02

(52) U.S. Cl. 360/99.08; 360/244; G9B/5.153; G9B/5.151; G9B/17.002

(57) ABSTRACT

A damping material to increase a damping ratio is disclosed. In one embodiment, an actuator arm assembly of a hard-disk drive (HDD) comprises an actuator arm. A viscoelastic layer is coupled with the actuator arm. A constraining layer is coupled with the viscoelastic layer on a side of the viscoelastic layer opposite the actuator arm. The coupling of the actuator arm, the viscoelastic layer, and the constraining layer occurs over an area which is a fraction of the area between the constraining layer and the actuator arm.

### TECHNICAL FIELD

Embodiments relate generally to the field of hard-disk drives (HDDs), and in particular to disk enclosures for HDDs.

### BACKGROUND

As hard-disk drive (HDD) storage capacity increases, the width of tracks for recording data is decreasing. In order to read and write data accurately, a magnetic head must be precisely positioned on narrow tracks. Flow-induced vibration of the actuator arm is a major impediment to positioning the magnetic head precisely. Therefore, reducing such vibration is an important issue. A vibration damping material comprising a constraining plate and a viscoelastic element, known as an arm damper, is conventionally used in this situation. However, as the track width becomes smaller, the vibration damping performance becomes inadequate in arm dampers having a simple structure.

One conventional method for damping arm vibration uses a constraining plate and a viscoelastic damping material which are bonded to the arm of the actuator over the whole area of the constraining plate. The viscoelastic damping material is bonded in such as way that it is held between the constraining plate and the arm of the actuator. Typically, the viscoelastic damping material and the constraining plate are the same size and all of the area of the viscoelastic damping material is bonded with the constraining plate on one side and all of the other side of the viscoelastic material is bonded with the actuator arm. In operation, when the arm deforms, there is relative displacement between the arm and the constraining plate because the intervening layer of viscoelastic damping material is less rigid. As a result, the viscoelastic damping undergoes shear deformation and the strain energy accumulates. The strain energy dissipates as heat energy, thereby attenuating the vibration of the arm.

Another conventional method for damping arm vibration uses what is known as a tuned mass damper. In this case, a mass is added to the actuator arm with a viscoelastic element interposed in order to attenuate a specific vibration mode. The resonance point of the arm and the resonance point of the vibrating system with one degree of freedom comprising the mass and the viscoelastic element are the same, so that the strain energy of the viscoelastic element is increased and the vibration energy is effectively dissipated.

### SUMMARY

A damping material to increase a damping ratio is disclosed. In one embodiment, an actuator arm assembly of a hard-disk drive (HDD) comprises an actuator arm. A viscoelastic layer is coupled with the actuator arm. A constraining layer is coupled with the viscoelastic layer on a side of the viscoelastic layer opposite the actuator arm. The coupling of the actuator arm, the viscoelastic layer, and the constraining layer occurs over an area which is a fraction of the area between the constraining layer and the actuator arm.

### DESCRIPTION OF THE DRAWINGS

The accompanying drawings, which are incorporated in and form a part of this specification, illustrate embodiments and, together with the description, serve to explain the embodiments. The drawings referred to in this description should not be understood as being drawn to scale except if specifically noted.

FIG. 1 is a plan view of a hard-disk drive (HDD), in accordance with one or more embodiments.

FIG. 2A is a perspective view of a rotary actuator of a hard disk drive (HDD) actuator including damping material to increase a damping ratio in accordance with an embodiment.

FIG. 2B is a perspective view of a rotary actuator of a hard disk drive (HDD) actuator including damping material to increase a damping ratio in accordance with an embodiment.

FIG. 3 is a graph showing frequency response of an arm of a rotary actuator using damping material to increase a damping ratio in accordance with one or more embodiments.

FIG. 4 is a perspective view showing a portion of an arm of a rotary actuator including damping material to increase a damping ratio in accordance with one embodiment.

FIG. 5 is a perspective view showing a portion of an arm of a rotary actuator including damping material to increase a damping ratio in accordance with one embodiment.

FIG. 6 is a perspective view showing a portion of an arm of a rotary actuator including damping material to increase a damping ratio in accordance with one embodiment.

FIG. 7 is a perspective view showing a portion of an arm of a rotary actuator including damping material to increase a damping ratio in accordance with one embodiment.

FIG. 8 is a perspective view showing a portion of an arm of a rotary actuator including damping material to increase a damping ratio in accordance with one embodiment.

### DESCRIPTION OF EMBODIMENTS

Reference will now be made in detail to various alternative embodiments. While numerous alternative embodiments will be described, it will be understood that they are not intended to be limiting. On the contrary, the described embodiments are intended to cover alternatives, modifications and equivalents, which may be included within the spirit and scope as defined by the appended claims.

Furthermore, in the following description of embodiments, numerous specific details are set forth in order to provide a thorough understanding. However, it should be appreciated that embodiments may be practiced without these specific details. In other instances, well known methods, procedures, and components have not been described in detail as not to unnecessarily obscure embodiments. Throughout the drawings, like components are denoted by like reference numerals, and repetitive descriptions are omitted for clarity of explanation if not necessary.

### Physical Description of Embodiments of a Damping Material to Increase a Damping Ratio

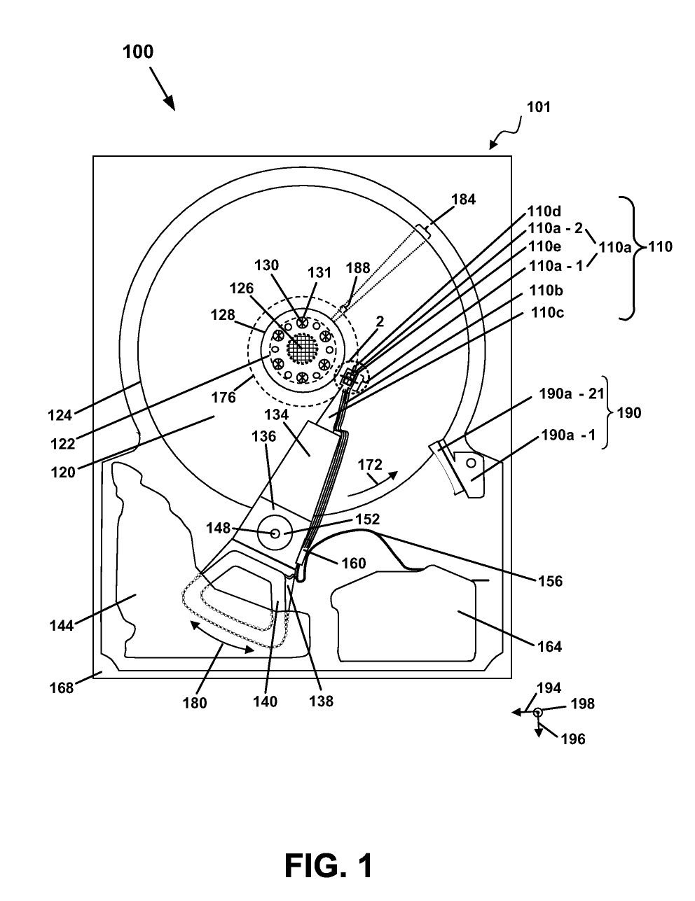

With further reference to FIG. 1, in accordance with one or more embodiments, the arrangement of components within HDD 101 is illustrated. HDD 101 includes a HGA 110 comprising a gimbal 110e, a head-slider 110a, and a plurality of suspension-lead pads (not shown). The head-slider 110a includes a slider 110a-1, and a magnetic-recording head 110a-2 coupled with the slider 110a-1. The HGA 110 further includes a lead-suspension 110b attached to the head-slider 110a, and a load beam 110c attached to a head-slider 110a, which includes the magnetic-recording head 110a-2 at a distal end of the head-slider 110a. The head-slider 110a is attached at the distal end of the load beam 110c to the gimbal 110e, which is attached to the load beam 110c. HDD 101 also includes at least one magnetic-recording disk 120 rotatably mounted on a spindle 126 and a spindle motor (not shown) mounted in a disk-enclosure base 168 and attached to the spindle 126 for rotating the magnetic-recording disk 120. Thus, the HGA 110 also includes a tongue 110d, which is used in loading and unloading the head-slider 110a from the magnetic-recording disk 120, using a load-unload ramp structure 190 including a load-unload ramp 190a-21 and bracket 190a-1. The magnetic-recording disk has an inside-diameter edge 122, and an outside-diameter edge 124, which are often informally referred to as the inside-diameter and the outside diameter, it being understood that these terms of art refer to the corresponding portion of the disk. The magnetic-recording head 110a-2 that includes a write element 110a-21, a so-called writer, and a read element 110a-22, a so-called reader, is disposed for respectively writing and reading information, referred to by the term of art, “data,” stored on the magnetic-recording disk 120 of HDD 101. The magnetic-recording disk 120, or a plurality (not shown) of magnetic-recording disks, may be affixed to the spindle 126 with a disk clamp 128. The disk clamp 128 is provided with fastener holes, for example, fastener hole 130, and clamps the magnetic-recording disk 120, or magnetic recording disks (not shown), to a hub (not shown) with fasteners, of which fastener 131 is an example. HDD 101 further includes an actuator arm 134 attached to HGA 110, a carriage 136, a voice-coil motor (VCM) that includes an armature 138 including a voice coil 140 attached to the carriage 136; and a stator 144 including a voice-coil magnet (not shown); the armature 138 of the VCM is attached to the carriage 136 and is configured to move the actuator arm 134 and HGA 110 to access portions of the magnetic-recording disk 120, as the carriage 136 is mounted on a pivot-shaft 148 with an interposed pivot-bearing assembly 152.

With further reference to FIG. 1, in accordance with one or more embodiments, electrical signals, for example, current to the voice coil 140 of the VCM, write signals to and read signals from the magnetic-recording head 110a-2, are provided by a flexible cable 156. Interconnection between the flexible cable 156 and the magnetic-recording head 110a-2 may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by the disk-enclosure base 168. The disk-enclosure base 168, also referred to as a base casting, depending upon whether the disk-enclosure base 168 is cast, in conjunction with an HDD cover (not shown) provides a sealed, except for a breather filter (not shown), protective disk enclosure for the information storage components of HDD 101.

With further reference to FIG. 1, in accordance with one or more embodiments, other electronic components (not shown), including a disk controller and servo electronics including a digital-signal processor (DSP), provide electrical signals to the spindle motor, the voice coil 140 of the VCM and the magnetic-recording head 110a-2 of HGA 110. The electrical signal provided to the spindle motor enables the spindle motor to spin providing a torque to the spindle 126 which is in turn transmitted to the magnetic-recording disk 120 that is affixed to the spindle 126 by the disk clamp 128; as a result, the magnetic-recording disk 120 spins in direction 172. The spinning magnetic-recording disk 120 creates an airflow including an air-stream, and a self-acting air bearing on which the air-bearing surface (ABS) of the head-slider 110a rides so that the head-slider 110a flies in proximity with the recording surface of the magnetic-recording disk 120 to avoid contact with a thin magnetic-recording medium of the magnetic-recording disk 120 in which information is recorded. The electrical signal provided to the voice coil 140 of the VCM enables the magnetic-recording head 110a-2 of HGA 110 to access a track 176 on which information is recorded. As used herein, “access” is a term of art that refers to operations in seeking the track 176 of the magnetic-recording disk 120 and positioning the magnetic-recording head 110a-2 on the track 176 for both reading data from, and writing data to, the magnetic-recording disk 120. The armature 138 of the VCM swings through an arc 180 which enables HGA 110 attached to the armature 138 by the actuator arm 134 to access various tracks on the magnetic-recording disk 120. Information is stored on the magnetic-recording disk 120 in a plurality of concentric tracks (not shown) arranged in sectors on the magnetic-recording disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element 110a-22 of the magnetic-recording head 110a-2 of HGA 110 reads the servo-burst-signal pattern which provides a position-error-signal (PES) to the servo electronics, which controls the electrical signal provided to the voice coil 140 of the VCM, enabling the magnetic-recording head 110a-2 to follow the track 176. Upon finding the track 176 and identifying a particular sectored track portion 188, the magnetic-recording head 110a-2 either reads data from the track 176, or writes data to the track 176 depending on instructions received by the disk controller from an external agent, for example, a microprocessor of a computer system.

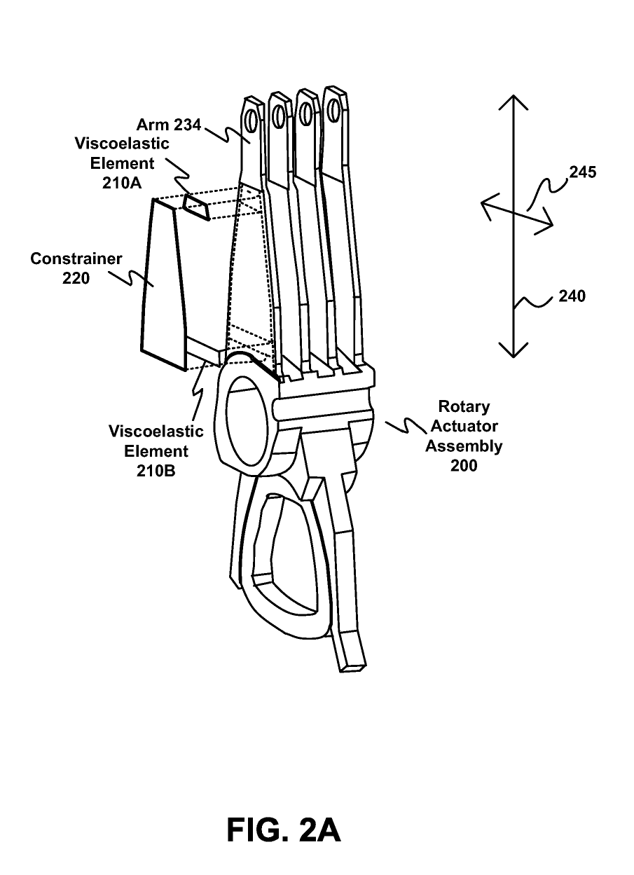

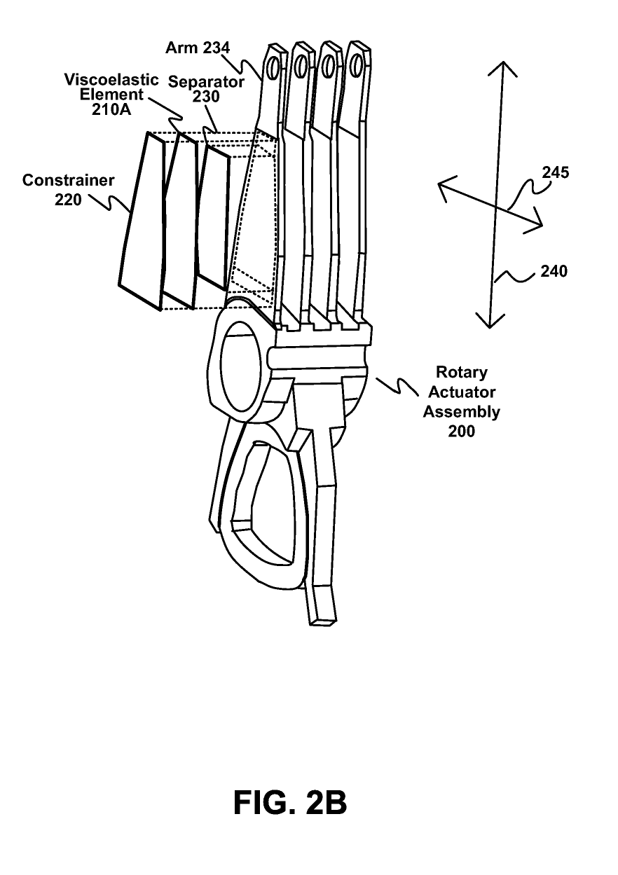

As shown in FIG. 1, the direction of arrow 196 is about parallel to the long side of the disk-enclosure base 168 of HDD 101; the direction of arrow 194 is perpendicular to arrow 196 and is about parallel to the short side of the disk-enclosure base 168 of HDD 101; and, arrow 198, which is indicated by the arrow head of arrow 198, is about perpendicular to the plane of the disk-enclosure base 168, as well as the plane of the recording surface of the magnetic recording disk 120, and therefore is perpendicular to arrows 194 and 196. Thus, the triad of arrows 194, 196 and 198 are related to one another by the right-hand rule for vectors in the direction of the arrows 194, 196 and 198 such that the cross product of the vector corresponding to arrow 194 and the vector corresponding to arrow 196 produces a vector parallel and oriented in the direction of the arrow 198. The triad of arrows 194, 196 and 198 is subsequently used to indicate the orientation of views for subsequently described drawings of HGA 110. Also as shown in FIG. 1, a reference circle 2 is provided to indicate the portion of the HGA 110 subsequently described in the discussion of FIGS. 2A & 2B.

As used herein, component parts of HDD 101 have different sides referred to by at least the following terms of art: a side facing into the direction 172 of motion of the magnetic-recording disk and, thus, into the direction of airflow, a leading-edge (LE) side; a side facing away from the direction 172 of motion of the magnetic-recording disk and, thus, away from the direction of airflow, a trailing-edge (TE) side.

As described above with reference to FIG. 1 embodiments encompass within their scope a HDD 101 that includes a magnetic-recording disk 120, a disk enclosure including a disk-enclosure base 168, a spindle motor affixed in the disk-enclosure base 168, for rotating the magnetic-recording disk 120, an actuator arm 134, and a HGA 110 attached to the actuator arm 134. In accordance with one or more embodiments, the HGA 110 includes a gimbal 110e, a head-slider 110a coupled with the gimbal 110e. In accordance with one or more embodiments, the head-slider includes a slider 110a-1, and a magnetic-recording head 110a-2 coupled with the slider 110a-1. In accordance with one or more embodiments, the magnetic-recording head 110a-2 includes a write element 110a-21 configured to write data to the magnetic-recording disk 120, a read element 110a-22 configured to read data from the magnetic-recording disk 120. In accordance with one or more embodiments, the HGA 110 is configured to support the head-slider 110a in proximity with a recording surface of the magnetic-recording disk 120 when the magnetic-recording disk 120 is rotated by the spindle motor, and the actuator arm 134 is configured to be pivoted by a voice coil motor for accessing data on the magnetic-recording disk 120. Furthermore, in accordance with one or more embodiments, actuator arm 134 is configured with a viscoelastic layer and a constraining layer coupled with the viscoelastic layer on a side of the viscoelastic layer opposite actuator arm 134. In accordance with one or more embodiments, the coupling of the actuator arm, the viscoelastic layer, and the constraining layer is performed over an area which is a fraction of the area between the constraining layer and the actuator arm which is less than the total area between the constraining layer and the actuator arm.

FIG. 2A is a perspective view of a rotary actuator assembly 200 of a hard disk drive (HDD) actuator including damping material to increase a damping ratio in accordance with an embodiment. In one or more embodiments, arm 134 is coupled with a layer viscoelastic material. In one or more embodiments, the layer of viscoelastic material is coupled with a constraining layer (e.g., constrainer 220 of FIG. 2A). In the embodiment of FIG. 2A, the layer of viscoelastic material comprises a first viscoelastic element 210A which is laterally coupled with arm 134 of rotary actuator assembly 200. Furthermore, a second viscoelastic element 210B is also laterally coupled with arm 134 of rotary actuator assembly 200. It is noted that the term “laterally” refers to the lateral axis of arm 134 as indicated by arrow 245 while the longitudinal axis of arm 134 is indicated by arrow 240 of FIG. 2A. In accordance with one or more embodiments, the term “laterally coupled” means that the longitudinal axis of the viscoelastic elements (e.g., 210A and 210B) are aligned along the lateral axis 245 of arm 134. In FIG. 2A, constrainer 220 is coupled with arm 134 via viscoelastic elements 210A and 210B. In accordance with the embodiment of FIG. 2A, the coupling of the actuator arm 134 and constrainer 220 is performed over an area which is a fraction of the area between the constrainer 220 and the actuator arm 134 which is less than the total area of constrainer 220.

As an example, in the embodiment shown in FIG. 2A, along the longitudinal axis 240 of arm 134, viscoelastic elements 210A and 210B each have a width of approximately 10% of the length of constrainer 220. As a result, constrainer 220 is bound with arm 134, via viscoelastic elements 210A and 210B, over a portion or fraction of its total area which is less than its total area. More specifically, constrainer 220 is bound with arm 134 at its ends over 20% of its total length while the middle 80% of the total length of constrainer 220 is not coupled with arm 134, or with a constraining layer. In an example embodiment, arm 134 is made of aluminum and is approximately 30 mm in length and 1 mm in thickness while constrainer 220 is made of stainless steel and is approximately 25 mm in length and 0.05 mm in thickness. In one embodiment, viscoelastic elements 210A and 210B are made of a polymer and are approximately 0.05 mm in thickness.

In accordance with one or more embodiments, it is possible to improve the vibration damping performance of an arm damper comprising a constraining layer or plate and a viscoelastic element by bonding only a part of the constraining layer (e.g., constrainer 220) to arm 134 using an interposed viscoelastic layer (e.g., viscoelastic elements 210A and 210B). In the embodiment shown in FIG. 2A, no viscoelastic material is provided in the region where constrainer 220 and arm 134 are not bonded. Instead, viscoelastic material (e.g., viscoelastic elements 210A and 210B) is separately provided at the wide side of arm 134 (e.g., the base side) and at the narrow side of arm 134 (e.g., the tip end). As a result, no bonding of constrainer 220 to arm 134 via intervening viscoelastic material occurs. It is noted that in the embodiment shown in FIG. 2A there is no hole or opening in the portion of arm 134 which is proximate to, or lying beneath, constrainer 220.

In accordance with one or more embodiments, a greater relative deformation of constrainer 220 and arm 134 is possible when only a part of constrainer 220 is bonded or coupled with arm 134 (e.g., via the viscoelastic layer such as viscoelastic elements 210A and 210B). One result of this greater relative deformation is that the strain energy of viscoelastic elements 210A and 210B is increased. Typically, the strain energy of the viscoelastic layer is proportional to the square of the strain, so the strain energy of the viscoelastic layer as a whole is greater when the viscoelastic layer is only provided on part of arm 134 and is strained by a large amount than when it is provided over the entire surface of arm 134 and is strained by a smaller amount. As a result, a greater dissipation of vibration energy is realized in one or more embodiments and the vibration damping performance is improved overall. In conventional damping systems, the viscoelastic layer would typically cover the entire area between the constraining layer and the actuator arm and bonding between the arm and constraining layer would occur across that entire area. As shown in FIG. 2A, rather than providing a viscoelastic layer which is equal to the total area of constrainer 220, viscoelastic elements 210A and 210B permit bonding of a fraction constrainer 220, which is less than its total area, with arm 134 which permits the greater relative deformation of constrainer 220 and arm 134 described above.

FIG. 2B is a perspective view of a rotary actuator 200 of a hard disk drive (HDD) actuator including damping material to increase a damping ratio in accordance with an embodiment. In the embodiment shown in FIG. 2B, rather than providing separate viscoelastic elements (e.g., 210A and 210B of FIG. 2A), a single viscoelastic element 210 is coupled with constrainer 220. In the embodiment shown in FIG. 2B, viscoelastic element 210 is the same size as constrainer 220. However, viscoelastic element 210 can be either larger or smaller than constrainer 220 in one or more embodiments. In the embodiment shown in FIG. 2B, a separator 230 is interposed between viscoelastic element 210 and arm 134 and is bonded or coupled with viscoelastic element 210. In accordance with various embodiments separator 230 can alternatively be bonded or coupled with arm 134 rather than with viscoelastic element 210. In the embodiment shown in FIG. 2B, arm 134 is bonded or coupled with viscoelastic element 210 in the regions of viscoelastic element 210 that are not covered by separator 230. Thus, arm 134 is not bonded or coupled with constrainer 220, either directly or via viscoelastic element 210, in the region of separator 230. In the embodiment shown in FIG. 2B, the length of separator 230 is equal to approximately 80% of the length of constrainer 220 and thus permits a bonding between constrainer 220 and arm 134 which is approximately equal to that described above with reference to FIG. 2A. As a result, rather than bonding arm 134 over the total area of constrainer 220, separator 230, in conjunction with viscoelastic element 210, permits bonding of a fraction of constrainer 220 which is less than its total area with arm 134 which permits the greater relative deformation of constrainer 220 and arm 134 described above. It is noted that in the embodiment shown in FIG. 2B there is no hole or opening in the portion of arm 134 which is proximate to, or lying beneath, constrainer 220.

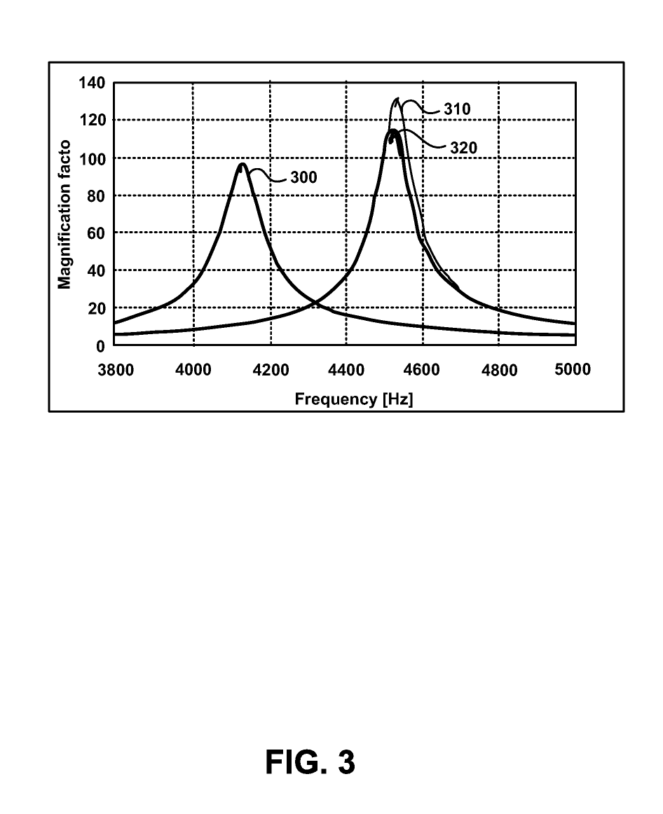

FIG. 3 is a graph showing frequency response of an arm of a rotary actuator using damping material to increase a damping ratio in accordance with one or more embodiments. In FIG. 3, response curve 310 shows the frequency response of a conventional damping system in which the arm, viscoelastic material, and constraining layer are bonded over the entire area of the constraining layer. The frequency response curves were generated using a laser Doppler vibrometer to measure vibration of the tip end of an actuator arm when the base of the arm was vibrated. Response curve 320 shows the frequency response of one or more embodiments in which there is a gap in the damping system as represented in, for example, FIGS. 2A, 5, and 7. As shown in FIG. 3, response curve 320 shows a reduction of approximately 13% in the vibration measured at the tip of the arm when compared with the example conventional damping system (e.g., response curve 310 of FIG. 3). Response curve 330 shows the frequency response of one or more embodiments which utilize a separator layer as represented in FIGS. 2B, 4, and 6. As shown in FIG. 3, response curve 330 shows a reduction of approximately 26% in the vibration measured at the tip of the arm when compared with the example conventional damping system (e.g., response curve 310 of FIG. 3).

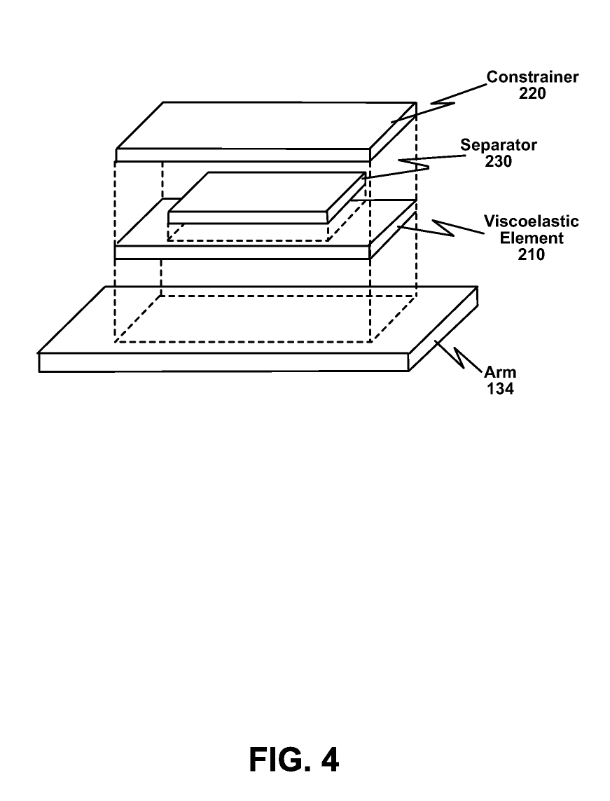

FIG. 4 is a perspective view showing a portion of an arm of a rotary actuator including damping material to increase a damping ratio in accordance with one embodiment. In the embodiment shown in FIG. 4, separator 230 is interposed between constrainer 220 and viscoelastic element 210 and is bonded or coupled with viscoelastic element 210. In the embodiment shown in FIG. 4, viscoelastic element 210 is again the same size as constrainer 220. However, viscoelastic element 210 can be either larger or smaller than constrainer 220 in one or more embodiments. In accordance with various embodiments separator 230 can alternatively be bonded or coupled with constrainer 220 rather than with viscoelastic element 210. In the embodiment shown in FIG. 4, arm 134 is bonded or coupled with viscoelastic element 210 while constrainer 220 is bonded or coupled with viscoelastic element 210 in the regions of viscoelastic element 210 that are not covered by separator 230. Thus, arm 134 is not bonded or coupled with constrainer 220, either directly or via viscoelastic element 210, in the region of separator 230. In the embodiment shown in FIG. 4, the length of separator 230 is equal to approximately 80% of the length of constrainer 220 and thus permits a bonding between constrainer 220 and arm 134 which is approximately equal to that described above with reference to FIG. 2A. As a result, rather than bonding arm 134 over the total area of constrainer 220 via viscoelastic element 210, separator 230, in conjunction with viscoelastic element 210, permits bonding of a fraction of constrainer 220 which is less than its total area with arm 134 which permits the greater relative deformation of constrainer 220 and arm 134 described above. This results in greater strain energy upon viscoelastic element 210 and a greater dissipation of vibration energy is realized in one or more embodiments and the vibration damping performance is improved overall. It is noted that in the embodiment shown in FIG. 4 there is no hole or opening in the portion of arm 134 which is proximate to, or lying beneath, constrainer 220.

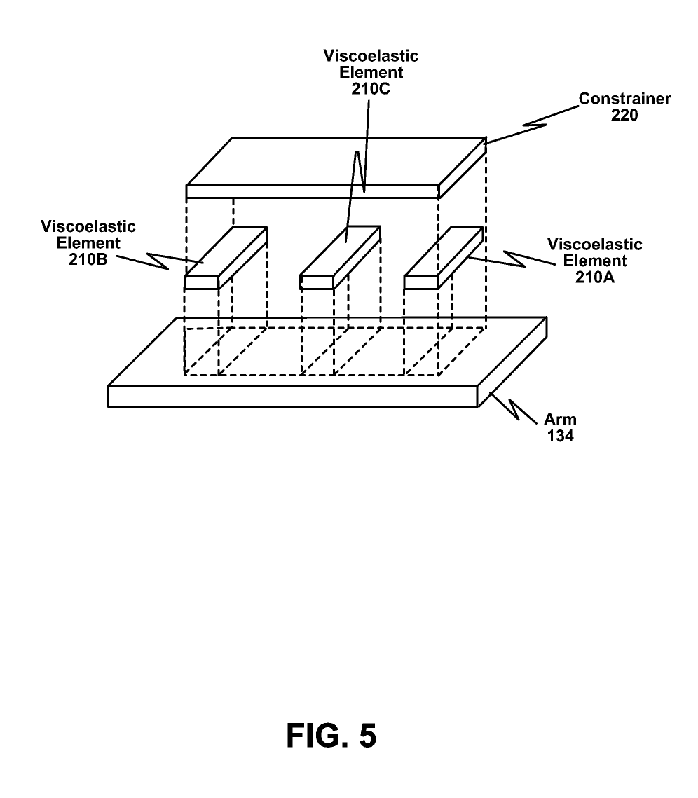

FIG. 5 is a perspective view showing a portion of an arm of a rotary actuator including damping material to increase a damping ratio in accordance with one embodiment. In the embodiment shown in FIG. 5, the layer of viscoelastic material comprises viscoelastic elements 210A and 210B as described with reference to FIG. 2A. In the embodiment shown in FIG. 5, a third viscoelastic element 210C is also laterally coupled with arm 134 and with constrainer 220. In accordance with one or more embodiments, a plurality of viscoelastic elements can be used to couple constrainer 220 and arm 134. In one embodiment, the width of each of viscoelastic elements 210A, 210B, 210C, etc., is approximately 10% of the length of constrainer 220. In accordance with one or more embodiments, additional viscoelastic elements (e.g., 210C) are placed in regions where there is a large amount of relative displacement of constrainer 220 relative to arm 134 such as the area between viscoelastic elements 210A and 210B. It is noted that in other embodiments, other factors may be used to determine the placement of additional viscoelastic elements (e.g., 210C) such as harmonic frequencies, or multiple regions in which there is a large amount of relative displacement of constrainer 220 relative to arm 134. As with the embodiments described above with reference to FIGS. 2A, 2B, and 4, rather than bonding arm 134 over the total area of constrainer 220, viscoelastic elements 210A, 210B, and 210C permit bonding of arm 134 with a fraction of constrainer 220 which is less than its total area which permits the greater relative deformation of constrainer 220 and arm 134 described above. This results in greater strain energy upon viscoelastic elements 210A, 210B, and 210C and a greater dissipation of vibration energy is realized in one or more embodiments and the vibration damping performance is improved overall. It is noted that in the embodiment shown in FIG. 5 there is no hole or opening in the portion of arm 134 which is proximate to, or lying beneath, constrainer 220.

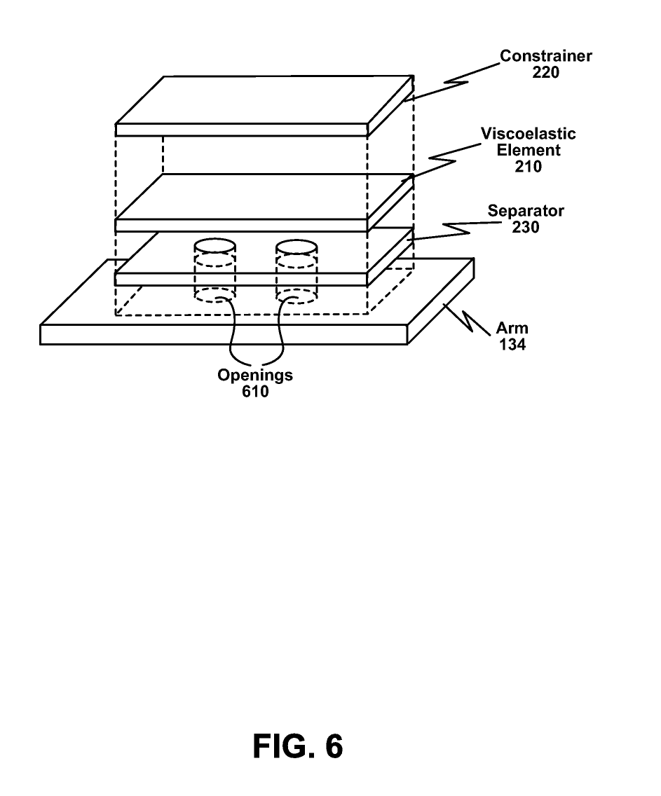

FIG. 6 is a perspective view showing a portion of an arm of a rotary actuator including damping material to increase a damping ratio in accordance with one embodiment. In the embodiment of FIG. 6, the outer shapes of constrainer 220, viscoelastic element 210, and arm 134 are approximately the same. However, viscoelastic element 210 can be either larger or smaller than constrainer 220 in one or more embodiments. A separator 230 is again disposed between viscoelastic element 210 and arm 134. In the embodiment of FIG. 5, separator 230 is configured with one or more openings 610. Again, separator 230 can be bonded or coupled with either of arm 134, or viscoelastic element 210 in various embodiments. In the embodiment of FIG. 5, bonding or coupling of arm 134 with viscoelastic element 210 occurs at the regions of separator 230 where openings 610 are located. As with the embodiments described above with reference to FIGS. 2A, 2B, 4, and 5, rather than bonding arm 134 over the total area of constrainer 220 via viscoelastic element 210, openings 610 of separator 230 permit bonding of arm 134 with a fraction of constrainer 220 which is less than its total area which permits the greater relative deformation of constrainer 220 and arm 134 described above. This results in greater strain energy upon viscoelastic element 210 and a greater dissipation of vibration energy is realized in one or more embodiments and the vibration damping performance is improved overall. It is noted that in the embodiment shown in FIG. 6 there is no hole or opening in the portion of arm 134 which is proximate to, or lying beneath, constrainer 220.

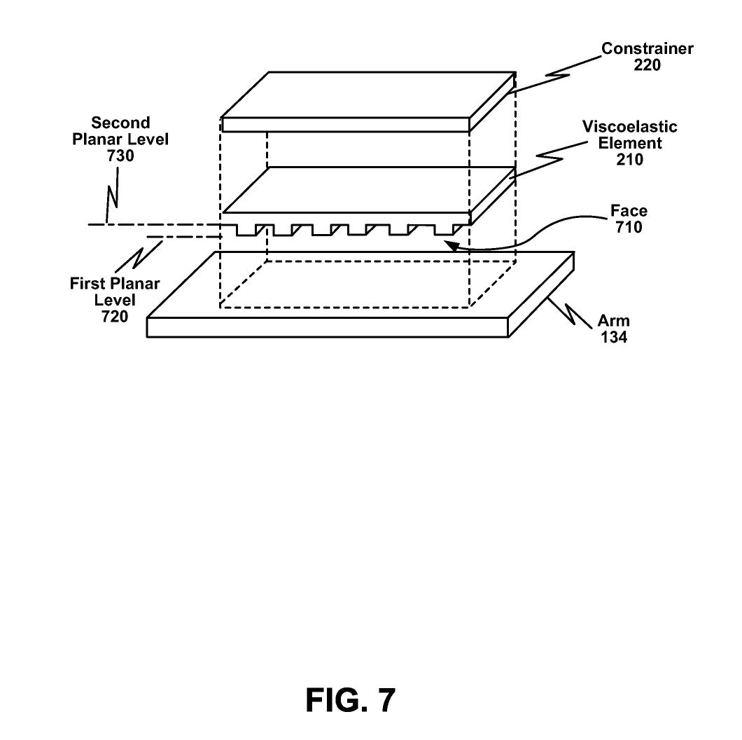

FIG. 7 is a perspective view showing a portion of an arm of a rotary actuator including damping material to increase a damping ratio in accordance with one embodiment. In the embodiment of FIG. 7, the outer shapes of constrainer 220, viscoelastic element 210, and arm 134 are approximately the same. However, viscoelastic element 210 can be either larger or smaller than constrainer 220 in one or more embodiments. In the embodiment shown in FIG. 7, viscoelastic element 210 is configured with one face (e.g., face 710 of FIG. 7) which is configured with multiple planar levels (e.g., first planar level 720 and second planar level 730). As a result, the portions of viscoelastic element 210 which are co-planar with first planar level 720 project out from viscoelastic element 210 relative to the portions of viscoelastic element 210 which are co-planar with second planar level 730. In the embodiment shown in FIG. 7, the portions of viscoelastic element 210 which are co-planar with first planar level 720 are bonded or coupled with arm 134. It is noted that in accordance with one or more embodiments, that the portions of viscoelastic element 210 that are co-planar with first planar level 720 can present a patterned appearance such as, but not limited to, dots, squares, diamonds, triangles, etc. Additionally, in accordance with one or more embodiments, both faces of viscoelastic element 210 can be configured with multiple planar levels so that both arm 134 and constrainer 220 are in contact with, and bonded to, a fraction of the total area of viscoelastic element 210 which is less than the total area of constrainer 220 as well. In the embodiment of FIG. 7, the flat face of viscoelastic element 210 is coupled or bonded with constrainer 220 while the multi-planar face of viscoelastic element 210 (e.g., face 710) is bonded or coupled with arm 134 in the areas of viscoelastic element 210 that are co-planar with first planar level 720. Alternatively, the flat face of viscoelastic element 210 can be coupled with arm 134 while the multi-planar face of viscoelastic element 210 is coupled with constrainer 220 in the areas of viscoelastic element 210 that are co-planar with first planar level 720 in or more embodiments. As with the embodiments described above with reference to FIGS. 2A, 2B, 4, 5, and 6, rather than coupling arm 134 over the total area of constrainer 220 via viscoelastic element 210, the viscoelastic element 210 shown in FIG. 7 permits bonding of arm 134 with a fraction of the total area of constrainer 220 which is less than the total area of constrainer 220 via viscoelastic element 210 which permits the greater relative deformation of constrainer 220 and arm 134 described above. This results in greater strain energy upon viscoelastic element 210 and a greater dissipation of vibration energy is realized in one or more embodiments and the vibration damping performance is improved overall. It is noted that in the embodiment shown in FIG. 7 there is no hole or opening in the portion of arm 134 which is proximate to, or lying beneath, constrainer 220.

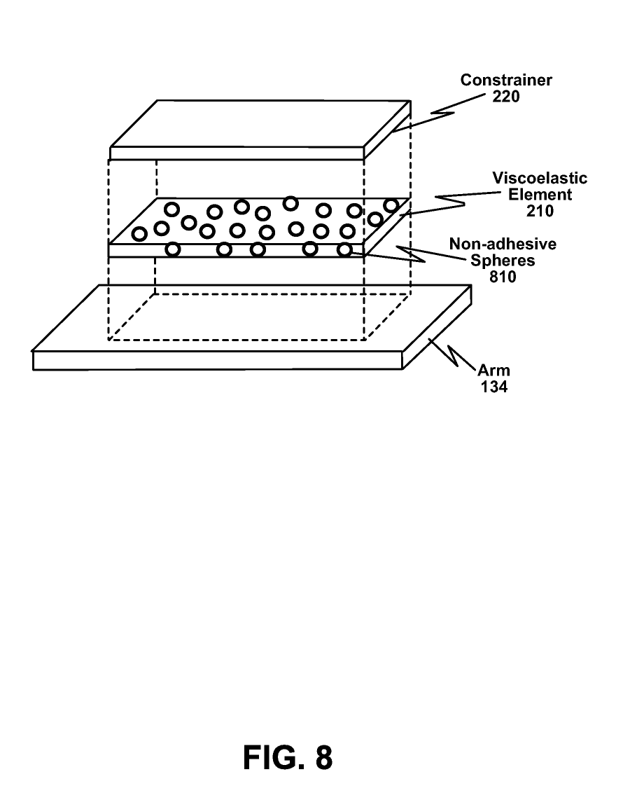

FIG. 8 is a perspective view showing a portion of an arm of a rotary actuator including damping material to increase a damping ratio in accordance with one embodiment. In the embodiment shown in FIG. 8, a plurality of non-adhesive spheres (e.g., 810 of FIG. 8) are mixed within the material comprising viscoelastic element 210. In one or more embodiments, the non-adhesive spheres 810 have a diameter which is substantially equal to the thickness of viscoelastic element 210. As a result, at least some of the surface of non-adhesive spheres 810 are exposed at the surface of viscoelastic element 210. In the example shown in FIG. 8, non-adhesive spheres 810 do not bond with either of arm 134 or constrainer 220. Thus, arm 134 and constrainer 220 are not bonded in the regions of viscoelastic element 210 via viscoelastic element 210 where surfaces of non-adhesive spheres 810 are exposed. This again results greater relative deformation of constrainer 220 and arm 134 described above. In other words, as with the embodiments described above with reference to FIGS. 2A, 2B, 4, 5, 6, and 7, rather than bonding arm 134 over the total area of constrainer 220 non-adhesive spheres 810 within viscoelastic element 210 permit bonding of arm 134 with a fraction of the total area of constrainer 220 which is less than the total area of constrainer 220. It is noted that the amount of strain upon viscoelastic element 210 can be controlled in part by controlling the density of non-adhesive spheres 810 which are disposed within viscoelastic element 210. It is noted that in the embodiment shown in FIG. 8 there is no hole or opening in the portion of arm 134 which is proximate to, or lying beneath, constrainer 220. It is noted that while the above descriptions of embodiments only show an arm dampering apparatus disposed upon one side of arm 134, in one or more embodiments another arm dampering apparatus can be disposed upon the opposite side of arm 134 as well.

The foregoing descriptions of specific embodiments have been presented for purposes of illustration and description. They are not intended to be exhaustive or to be limiting to the precise forms disclosed, and many modifications and variations are possible in light of the above teaching. The embodiments described herein were chosen and described in order to best explain principles and their practical application, to thereby enable others skilled in the art to best utilize various embodiments with various modifications as are suited to the particular use contemplated. It is intended that the scope be defined by the Claims appended hereto and their equivalents.

What is claimed is:

1. An actuator arm assembly for a hard-disk drive (HDD) comprising:
an actuator arm;
a viscoelastic layer coupled with said actuator arm; and
a constraining layer coupled with said viscoelastic layer on a side of said viscoelastic layer opposite said actuator arm and wherein the coupling of said actuator arm, said viscoelastic layer, and said constraining layer is performed over an area which is a fraction of the total area between said constraining layer and said actuator arm.

2. The actuator arm assembly of claim 1 wherein said viscoelastic layer further comprises:
a first viscoelastic element laterally coupled with said actuator arm at a first location of said actuator arm; and
a second viscoelastic element laterally coupled with said actuator arm at a second location of said actuator arm and wherein said constraining layer is coupled with said first viscoelastic element and said second viscoelastic element.

3. The actuator arm assembly of claim 2 further comprising:
at least one additional viscoelastic element laterally coupled with said actuator arm and disposed between said first viscoelastic element and said second viscoelastic element at a position to reduce the relative displacement of said actuator arm and said constraining layer.

4. The actuator arm assembly of claim 1 wherein said viscoelastic layer is configured with at least one face configured to have a first planar level and a second planar level and wherein coupling of said viscoelastic layer with either of said actuator arm and said constraining layer occurs at a region where said first planar level is located.

5. The actuator arm assembly of claim 1 wherein said viscoelastic layer further comprises:
at least one region within said viscoelastic layer comprising a non-adhesive material which is not coupled with said actuator arm and with said viscoelastic layer in said at least one region within said viscoelastic layer where said non-adhesive material is located.

6. The actuator arm assembly of claim 1 further comprising:
a separator layer disposed between said actuator arm and said viscoelastic layer and wherein said actuator arm and said viscoelastic layer are not coupled where said separator layer is located.

7. The actuator arm assembly of claim 1 further comprising:
a separator layer disposed between said viscoelastic layer and said constraining layer and wherein said viscoelastic layer and said constraining layer are not coupled where said separator layer is located.

8. The actuator arm assembly of claim 1 further comprising:
a separator layer comprising at least one opening and wherein coupling of said viscoelastic layer with either of said actuator arm and said constraining layer occurs where said at least one opening is located.

9. A disk drive comprising:
at least one data storage disk rotatably mounted in said disk drive; and
a rotary actuator comprising at least one actuator arm, said at least one actuator arm having a read-write head, said at least one actuator arm further comprising;
a viscoelastic layer coupled with said actuator arm; and
a constraining layer coupled with said viscoelastic layer on a side of said viscoelastic layer opposite said actuator arm and wherein the coupling of said actuator arm, said viscoelastic layer, and said constraining layer is performed over an area which is a fraction of the total area between said constraining layer and said actuator arm.

10. The disk drive of claim 9 wherein said viscoelastic layer further comprises:
a first viscoelastic element laterally coupled with said actuator arm at a first location of said actuator arm; and
a second viscoelastic element laterally coupled with said actuator arm at a second location of said actuator arm and wherein said constraining layer is coupled with said first viscoelastic element and said second viscoelastic element.

11. The disk drive of claim 10 further comprising:
at least one additional viscoelastic element laterally coupled with said actuator arm and disposed between said first viscoelastic element and said second viscoelastic element.

12. The disk drive of claim 11 wherein said at least one additional viscoelastic element is disposed between said first viscoelastic element and said second viscoelastic element at a position to reduce the relative displacement of said actuator arm and said constraining layer.

13. The disk drive of claim 9 wherein said viscoelastic layer is configured with at least one face configured to have a first planar level and a second planar level and wherein coupling of said viscoelastic layer with either of said actuator arm and said constraining layer occurs at a region where said first planar level is located.

14. The disk drive of claim 9 wherein said viscoelastic layer further comprises:
at least one region within said viscoelastic layer comprising a non-adhesive material which is not coupled with said actuator arm and with said viscoelastic layer in said at least one region within said viscoelastic layer where said non-adhesive material is located.

15. The disk drive of claim 9 further comprising:
a separator layer disposed between said actuator arm and said viscoelastic layer and wherein said actuator arm and said viscoelastic layer are not coupled where said separator layer is located.

16. The disk drive of claim 9 further comprising:
a separator layer disposed between said viscoelastic layer and said constraining layer and wherein said viscoelastic layer and said constraining layer are not coupled where said separator layer is located.

17. The disk drive of claim 9 further comprising:
a separator layer comprising at least one opening and wherein coupling of said viscoelastic layer with either of said actuator arm and said constraining layer occurs where said at least one opening is located.

18. A hard-disk drive (HDD) including an actuator arm configured with a damping material to increase a damping ratio, said HDD comprising:
a magnetic-recording disk;
a disk enclosure comprising a disk-enclosure base;
a spindle motor affixed in said disk-enclosure base, for rotating said magnetic-recording disk;
an actuator arm configured with a viscoelastic layer coupled with said actuator arm and a constraining layer coupled with said viscoelastic layer on a side of said viscoelastic layer opposite said actuator arm and wherein the coupling of said actuator arm, said viscoelastic layer, and said constraining layer is performed over an area which is a fraction of the total area between said constraining layer and said actuator arm; and
a HGA attached to said actuator arm, said HGA comprising:
a gimbal;
a head-slider coupled with said gimbal, comprising:
a slider;
a magnetic-recording head coupled with said slider, said magnetic-recording head comprising:
a write element configured to write data to said magnetic-recording disk; and
a read element configured to read data from said magnetic-recording disk.

19. The hard-disk drive of claim 18 wherein said viscoelastic layer further comprises:
a first viscoelastic element laterally coupled with said actuator arm at a first location of said actuator arm; and
a second viscoelastic element laterally coupled with said actuator arm at a second location of said actuator arm and wherein said constraining layer is coupled with said first viscoelastic element and said second viscoelastic element.

20. The hard-disk drive of claim 19 further comprising:
at least one additional viscoelastic element laterally coupled with said actuator arm and disposed between said first viscoelastic element and said second viscoelastic element at a position to reduce the relative displacement of said actuator arm and said constraining layer.

21. The hard-disk drive of claim 18 wherein said viscoelastic layer is configured with at least one face configured to have a first planar level and a second planar level and wherein coupling of said viscoelastic layer with either of said actuator arm and said constraining layer occurs at a region where said first planar level is located.

22. The hard-disk drive of claim 18 wherein said viscoelastic layer further comprises:
at least one region within said viscoelastic layer comprising a non-adhesive material which is not coupled with said actuator arm and with said viscoelastic layer in said at least one region within said viscoelastic layer where said non-adhesive material is located.

23. The hard-disk drive of claim 18 further comprising:
a separator layer disposed between said actuator arm and said viscoelastic layer and wherein said actuator arm and said viscoelastic layer are not coupled where said separator layer is located.

24. The hard-disk drive of claim 18 further comprising:
a separator layer disposed between said viscoelastic layer and said constraining layer and wherein said viscoelastic layer and said constraining layer are not coupled where said separator layer is located.

25. The hard-disk drive of claim 18 further comprising:
a separator layer comprising at least one opening and wherein coupling of said viscoelastic layer with either of said actuator arm and said constraining layer occurs where said at least one opening is located.
